(19) United States
(12) Patent Application Publication
(10) Pub. No.: US 2024/0128494 A1
(43) Pub. Date: Apr. 18, 2024

(54) POUCH TYPE ALL-SOLID-STATE BATTERY INCLUDING REFERENCE ELECTRODE

(71) Applicants: HYUNDAI MOTOR COMPANY, Seoul (KR); KIA CORPORATION, Seoul (KR)

(72) Inventors: Jae Ho Shin, Seoul (KR); Ji Chang Kim, Seoul (KR); Hyun Min Seo, Seoul (KR); Young Jin Nam, Seoul (KR); Ga Young Choi, Busan (KR)

(73) Assignees: HYUNDAI MOTOR COMPANY, Seoul (KR); KIA CORPORATION, Seoul (KR)

(21) Appl. No.: 18/242,126

(22) Filed: Sep. 5, 2023

(30) Foreign Application Priority Data
Oct. 18, 2022 (KR) 10-2022-0133691

(51) Int. Cl. H01M 10/0562; H01M 4/70; H01M 10/0565; H01M 50/569

(52) U.S. Cl. CPC H01M 10/0562; H01M 4/70; H01M 10/0565; H01M 50/569; H01M 2004/021

(57) ABSTRACT

A pouch type all-solid-state battery including a reference electrode is disclosed. In the all-solid-state battery, a potential variation of each electrode is accurately measured because the ion transfer path between the reference electrode and a positive electrode/negative electrode is short. Accordingly, the all-solid-state battery secures a desired cell performance while having battery specifications similar to actual battery specifications.

### CROSS-REFERENCE TO RELATED APPLICATION

This application claims priority, under 35 U.S.C. § 119(a), to Korean Patent Application No. 10-2022-0133691, filed on Oct. 18, 2022, the entire contents of which are incorporated herein by reference.

### BACKGROUND

### (a) Technical Field

The present disclosure relates to a pouch type all-solid-state battery including a reference electrode.

### (b) Background Art

A secondary battery, including an all-solid-state battery, has a two-electrode configuration and, as such, calculates a voltage of a cell through a relative potential difference between a positive electrode and a negative electrode. During charging/discharging operations of the secondary battery, potentials of the positive electrode and the negative electrode are simultaneously varied. Since there is no separate electrode to serve as a reference for a voltage, it is impossible to measure a reaction mechanism of each electrode and a variation in voltage that occur as a result of the reaction mechanism. Although an electrochemical reaction mechanism may be inferred from an aspect of such a voltage variation, this is difficult because measurement of the voltage variation is impossible.

Thus, a third electrode to serve as a reference is required for analysis of reaction of each electrode in a separated state, and the third electrode is referred to as a “reference electrode (RE)”. The reference electrode has a constant reaction voltage depending on the current, and if is used to construct a three-electrode cell, the reference electrode only measures a voltage without application of current thereto. In the case of a lithium secondary battery (LIB) using a liquid electrolyte, a three-electrode cell may be easily configured. However, in the case of an all-solid-state battery using a solid electrolyte, separate cell design is required. For this reason, measured voltages of three-electrode cells for the all-solid-state battery may be different in accordance with different design structures of the cells. In order to obtain an accurate experimental value, a specific design is required.

The statements in this BACKGROUND section merely provide background information related to the present disclosure and may not constitute prior art.

### SUMMARY OF THE DISCLOSURE

The present disclosure has been made in an effort to solve the above-described problems associated with the prior art, and an object of the present disclosure is to provide a pouch type all-solid-state battery including a reference electrode, which may secure a desired cell performance while having battery specifications similar to actual battery specifications.

Objects of the present disclosure are not limited to the above-described objects, and other objects of the present disclosure not yet described should be more clearly understood by those having ordinary skill in the art from the following detailed description. In addition, objects of the present disclosure may be accomplished by means defined in the appended claims and combinations thereof.

In one aspect, the present disclosure provides an all-solid-state battery including a first current collector layer, a first electrode layer disposed on the first current collector layer, a solid electrolyte layer disposed on the first electrode layer, and a second electrode layer disposed on the solid electrolyte layer. The all-solid-state battery further includes a second current collector layer disposed on the second electrode layer, an ion transfer layer disposed on the second current collector layer, and a reference electrode disposed on the ion transfer layer. In particular, the second current collector layer includes a hole formed to extend through the second current collector layer in a thickness direction, and at least a portion of the ion transfer layer fills the hole.

In an embodiment, the first electrode layer may have a thickness of 200 μm or less.

In another embodiment, the solid electrolyte layer may have a thickness of 150 μm or less.

In still another embodiment, the second electrode layer may have a thickness of 200 μm or less.

In yet another embodiment, the second current collector layer may include one or more holes.

In yet another embodiment, the hole may be disposed at a central portion of the second current collector layer.

In yet another embodiment, the hole may have a diameter of 1 to 5 mm.

In yet another embodiment, the ion transfer layer may include a lithium ion conductive material.

In yet another embodiment, the lithium ion conductive material may include an oxide-based solid electrolyte, a sulfide-based solid electrolyte, a polymer electrolyte, or a combination thereof.

In yet another embodiment, the at least a portion of the ion transfer layer may contact the second electrode layer.

In yet another embodiment, an area of the ion transfer layer may be greater than an area of the reference electrode.

In yet another embodiment, an area of the ion transfer layer may be greater than an area of the second electrode layer.

In yet another embodiment, the reference electrode may include lithium or a lithium alloy.

In yet another embodiment, an area of the reference electrode is 80 to 90% of an area of the second electrode layer.

In yet another embodiment, a distance between one surface of the ion transfer layer facing the reference electrode and the first current collector layer is 1 mm or less.

Other aspects and embodiments of the present disclosure are discussed infra.

The above and other features of the present disclosure are discussed infra.

The effects of the embodiments of the present disclosure are not limited to the above-described effects and other effects which are not described herein may be derived by those having ordinary skill in the art from the following description.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure, and wherein:

FIG. 1 illustrates a pouch type all-solid-state battery including a reference electrode according to an embodiment of the present disclosure;

FIG. 2 is a plan view of the pouch type all-solid-state battery including the reference electrode according to the embodiment of the present disclosure;

FIG. 3 briefly illustrates a pouch type all-solid-state battery according to a comparative example;

FIG. 4 is a graph showing results of a pouch type all-solid-state battery according to an embodiment of the present disclosure; and

FIG. 5 is a graph showing results of a pouch type all-solid-state battery according to a comparative example.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes should be determined in part by the particular intended application and usage environment.

In the figures, reference numbers refer to the same or equivalent parts of the present disclosure throughout the several figures of the drawing.

### DETAILED DESCRIPTION

The above and other objectives, features and advantages of the present disclosure are more clearly understood from the following forms taken in conjunction with the accompanying drawings. However, the present disclosure is not limited to various forms disclosed herein, and may be modified into different forms. These forms are provided to thoroughly explain the present disclosure and to sufficiently convey the spirit of the present disclosure to those skilled in the art.

Throughout the drawings, similar reference numerals refer to similar elements. For the sake of clarity of the present disclosure, the dimensions of structures are depicted as being larger than the actual sizes thereof. Although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

In the present disclosure, the terms “comprise”, “include”, “have”, etc., specify the presence of stated features, integers, steps, operations, elements, components, or combinations thereof, but do not preclude the presence or addition of one or more other features, integers, steps, operations, elements, components, or combinations thereof. Also, it should be understood that, when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

When a component, device, element, or the like of the present disclosure is described as having a purpose or performing an operation, function, or the like, the component, device, or element should be considered herein as being “configured to” meet that purpose or to perform that operation or function.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless indicated otherwise. Moreover, when such a range pertains to integer values, all integers including the minimum value to the maximum value are included, unless indicated otherwise.

A conventional all-solid-state battery including a reference electrode has a pressed-powder cell configuration and, as such, is constituted by small-area electrodes having a diameter of less than 12 pi in accordance with structural characteristics thereof. Specifications of the battery are greatly different from battery specifications applied to practical electronic products in terms of capacity, pressure, resistance, etc. In order to solve such a problem, the all-solid-state battery of the present disclosure takes the form of a pouch type design.

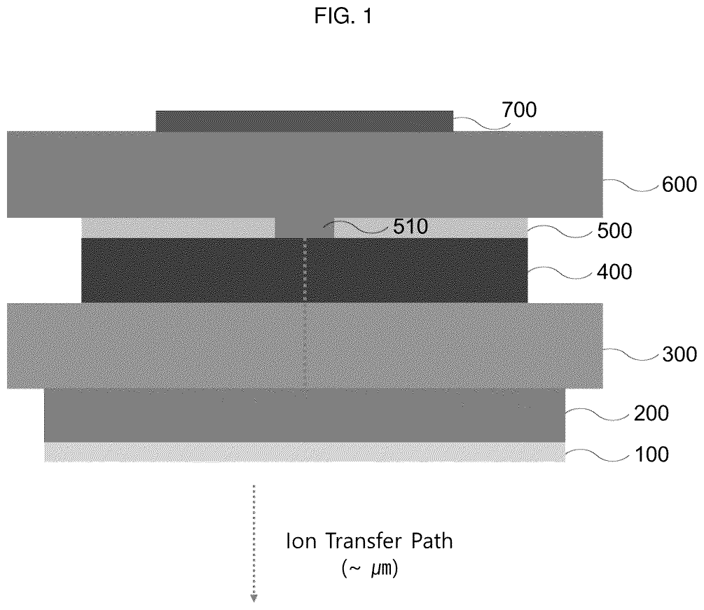

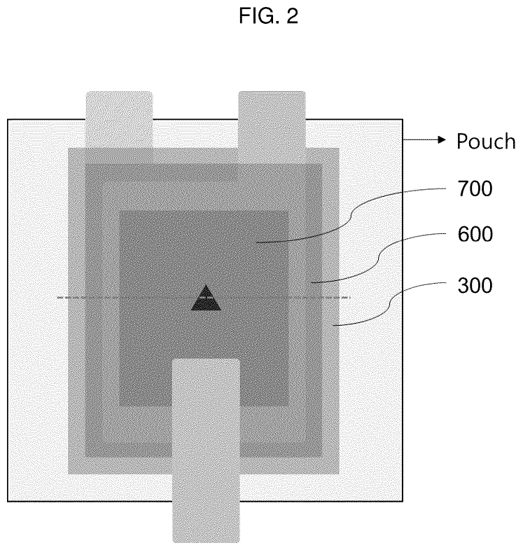

FIG. 1 shows a pouch type all-solid-state battery including a reference electrode according to an embodiment of the present disclosure. FIG. 2 is a plan view of the pouch type all-solid-state battery including the reference electrode according to the embodiment of the present disclosure. Referring to FIGS. 1 and 2, the all-solid-state battery includes a first current collector layer 100, a first electrode layer 200, a solid electrolyte layer 300, a second electrode layer 400, a second current collector layer 500, an ion transfer layer 600, and a reference electrode 700.

The first current collector layer 100 may be a cathode current collector or an anode current collector. In one embodiment, the first current collector layer 100 may be an anode current collector.

The first current collector layer 100 may be a plate, sheet or thin film type substrate made of a material having electrical conductivity. The first current collector layer 100 may include a material not reacting with lithium. In detail, the first current collector layer 100 may include nickel (Ni), copper (Cu), stainless steel (SUS), or a combination thereof.

The thickness of the first current collector layer 100 is not limited to a specific one, but may be in a range of 1 to 30 μm.

The first electrode layer 200 may include an anode active material, a solid electrolyte, a binder, etc.

The anode active material is not limited to a specific one, but may be, for example, a carbon active material or a metal active material.

The carbon active material may be graphite such as mesocarbon microbeads (MCMB), highly-oriented pyrolytic graphite (HOPG), etc. or amorphous carbon such as hard carbon, soft carbon, etc.

The metal active material may be In, Al, Si, Sn, an alloy containing at least one thereof, etc.

The solid electrolyte may be an oxide solid electrolyte or a sulfide solid electrolyte. In one embodiment, a sulfide-based solid electrolyte having high lithium ion conductivity may be used. Although the sulfide-based solid electrolyte is not limited to a specific one, the sulfide-based solid electrolyte may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like.

The binder may be butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like.

The first electrode layer 200 may include 70 to 90 wt. % of the anode active material, 5 to 25 wt. % of the solid electrolyte, and 1 to 5 wt. % of the binder.

The first electrode layer 200 may have a thickness of 200 μm or less.

The solid electrolyte layer 300 may be disposed between the first electrode layer 200 and the second electrode layer 400 and, as such, may be configured such that lithium ions may migrate between the first electrode layer 200 and the second electrode layer 400.

The solid electrolyte layer 300 may include an oxide-based solid electrolyte or a sulfide-based solid electrolyte. In one embodiment, a sulfide-based solid electrolyte having high lithium ion conductivity may be used. In detail, the solid electrolyte may have lithium ion conductivity of 0.3 mS/cm or more. Although the sulfide-based solid electrolyte is not limited to a specific one, the sulfide-based solid electrolyte may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like.

The solid electrolyte layer 300 may have a thickness of 150 μm or less.

The second electrode layer 400 may include a cathode active material, a solid electrolyte, a conductive material, a binder, etc.

The cathode active material may be an oxide active material or a sulfide active material.

The oxide active material may be a rock salt layer type active material such as LiCoO₂, LiMnO₂, LiNiO₂, LiVO₂, Li₁₊ₓNi_{1/3}Co_{1/3}Mn_{1/3}O₂ or the like, a spinel type active material such as LiMn₂O₄, Li(Ni_{0.5}Mn_{1.5})O₄ or the like, an inverse spinel type active material such as LiNiVO₄, LiCoVO₄ or the like, an olivine type active material such as LiFePO₄, LiMnPO₄, LiCoPO₄, LiNiPO₄ or the like, a silicon-containing active material such as Li₂FeSiO₄, Li₂MnSiO₄ or the like, a rock salt layer type active material, a part of a transition metal of which is substituted by a different kind of metal, such as LiNi_{0.8}Co_{(0.2-x)}AlₓO₂ (0<x<0.2), a spinel type active material, a part of a transition metal of which is substituted by a different kind of metal, such as Li₁₊ₓMn_{2-x-y}M_{y}O₄ (M being at least one selected from the group consisting of Al, Mg, Co, Fe, Ni and Zn, and 0<x+y<2), and lithium titanate such as Li₄Ti₅O₁₂ or the like

The sulfide active material may be copper Chevrel, iron sulfide, cobalt sulfide, nickel sulfide, or the like.

The solid electrolyte may be an oxide solid electrolyte or a sulfide solid electrolyte. In one embodiment, a sulfide-based solid electrolyte having high lithium ion conductivity may be used. Although the sulfide-based solid electrolyte is not limited to a specific one, the sulfide-based solid electrolyte may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like.

The conductive material may be carbon black, conductive graphite, ethylene black, graphene, or the like.

The binder may be butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like.

The second electrode layer 400 may include 80 to 90 wt. % of the cathode active material, 5 to 15 wt. % of the solid electrolyte, 1 to 5 wt. % of the conductive material, and 1 to 5 wt. % of the binder.

The second electrode layer 400 may have a thickness of 200 μm or less.

The second current collector layer 500 may be a cathode current collector or an anode current collector. In one embodiment, the second current collector layer 500 may be a cathode current collector.

The second current collector layer 500 may be a plate, sheet or thin film type substrate made of a material having electrical conductivity. Although the second current collector layer 500 is not limited to a specific one, the second current collector layer 500 may include, for example, aluminum (AI), stainless steel (SUS), or the like.

Conventionally, a reference electrode, which takes the form of a wire, is disposed between solid electrolyte layers, to which ions are transferred, in order to contact the solid electrolyte layers. When the reference electrode is disposed as mentioned above, there is a possibility that the solid electrolyte layers may be damaged, or interfacial resistance may be increased. As a result, there is a risk that characteristics different from an actual cell performance are exhibited. In other words, conventional all-solid-state batteries may have battery specifications greatly different from actual battery specifications in terms of cell structure and, as such, additional disposition of a reference electrode may badly affect the cell performance.

In order to solve the above-mentioned problems, in one embodiment of the present disclosure, the second current collector layer 500 includes a hole 510 formed through the second current collector layer 500 in a thickness direction, and at least a portion of the ion transfer layer 600 fills the hole 510.

The second current collector layer 500 may include one or more holes 510.

The hole 510 may be disposed in a reaction region where the first electrode layer 200, the solid electrolyte layer 300, and the second electrode layer 400 overlap one another. For example, the hole 510 may be disposed at a central portion of the second current collector layer 500.

The hole 510 may have a diameter in a range of 1 to 5 mm. When the diameter of the hole 510 exceeds 5 mm, an unreactive region increases due to peeling-off of the current collector. As a result, degradation in cell performance may occur. Considering a typical electrode area, the range of 1 to 5 mm corresponds to a local area and therefore has no influence on cell performance.

The second current collector layer 500 has a thickness in a range of 1 to 30 μm.

The ion transfer layer 600 may include a lithium ion conductive material.

The lithium ion conductive material may include an oxide-based solid electrolyte, a sulfide-based solid electrolyte, a polymer electrolyte, or a combination thereof.

In one embodiment, a sulfide-based solid electrolyte having high lithium ion conductivity may be used. In detail, the sulfide-based solid electrolyte may have lithium ion conductivity of 0.3 mS/cm or more.

Although the sulfide-based solid electrolyte is not limited to a specific one, the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like.

At least a portion of the ion transfer layer 600 may fill the hole 510. In detail, at least a portion of the ion transfer layer 600 may contact the second electrode layer 400.

The area of the ion transfer layer 600 may be greater than the area of the reference electrode 700 in order to prevent inner short circuit between the reference electrode 700 and the second electrode layer 400.

The area of the ion transfer layer 600 may be greater than the area of the second electrode layer 400 in order to prevent pressure concentration.

Although the ion transfer layer 600 is not limited in terms of thickness, so long as ion transfer is secured, the thickness of the ion transfer layer 600 may be equal to, for example, the thickness of the solid electrolyte layer 300.

The reference electrode 700 may have softness.

The reference electrode 700 may take the form of a thin film.

The reference electrode 700 may include lithium or a lithium alloy. The lithium alloy may be a lithium-indium (Li—In) alloy.

The area of the reference electrode 700 may be 80 to 90% of the area of the second electrode layer 400. When the area of the reference electrode 700 is less than 80% of the area of the second electrode layer 400, cell failure may occur due to non-uniform pressing in an ultra-high pressure process. When the area of the reference electrode 700 exceeds 90% of the area of the second electrode layer 400, alignment of cells may be difficult upon assembling the cells, thereby causing cell failure.

The distance between one surface of the ion transfer layer 600 facing the reference electrode 700 and the first current collector layer 100, i.e., the length of an ion transfer path, may be 1 mm or less. This distance may be a maximum distance.

In one embodiment, the distance may be 400 μm or less.

As compared to conventional cases, the ion transfer path between the reference electrode and the positive electrode/negative electrode is short and, as such, there is an effect enabling accurate measurement of a potential variation of each electrode.

In another embodiment of the present disclosure, a method of manufacturing a pouch type all-solid-state battery including a reference electrode may include: forming a first current collector layer and forming a first electrode layer by coating a first active material on the first current collector layer. The method further includes: forming a solid electrolyte layer on the first electrode layer, forming a second electrode layer by coating a second active material on the solid electrolyte layer, forming a second current collector layer on the second electrode layer, and forming a hole extending through the second current collector layer in a thickness direction. The method further includes forming an ion transfer layer on the second current collector layer, forming a reference electrode on the ion transfer layer, thereby forming a stacked structure, and pressing the stacked structure.

The hole may be formed using a punch, before coating of the second active material.

The hole may be formed by peeling off at least a portion of the second current collector layer in a coated state of the second active material.

Pressing of the staked structure may be performed under a pressure in a range of 100 to 500 MPa using warm isostatic pressing (WIP).

When the stacked structure is pressed in a high-pressure WIP process as described above, bonding force of the stacked structure may be strengthened, and the ion transfer layer may penetrate the hole in a depth direction by virtue of softness of the ion transfer layer and, as such, at least a portion of the ion transfer layer may fill the hole. Accordingly, the ion transfer layer may be a sulfide-based solid electrolyte.

Hereinafter, the present disclosure is described in detail with reference to the following example and comparative example. However, the technical scope of the present disclosure is not limited to the following example.

### Example

In order to evaluate performance of an all-solid-state battery, a pouch-type all-solid-state battery, as shown in FIGS. 1 and 2, was manufactured. For a reference electrode, a lithium metal foil was used. A three-electrode cell was configured by stacking a first electrode layer, a solid electrolyte layer, a second electrode layer, an ion transfer layer, and a reference layer in this order under the condition that the first electrode layer is a negative electrode, and the second electrode layer is a positive electrode. The area of the first electrode layer is slightly greater than the area of the second electrode layer. Peeling-off (punching) of a second current collector layer was manually performed. The resultant assembly was vacuum-sealed in a pouch, and an ultra-high pressure was then applied thereto through a WIP process. Thicknesses of the first and second electrode layers are in a range of 10 to 100 μm, and thicknesses of the solid electrolyte layer and the ion transfer layer are in a range of 30 to 150 μm.

### Comparative Example

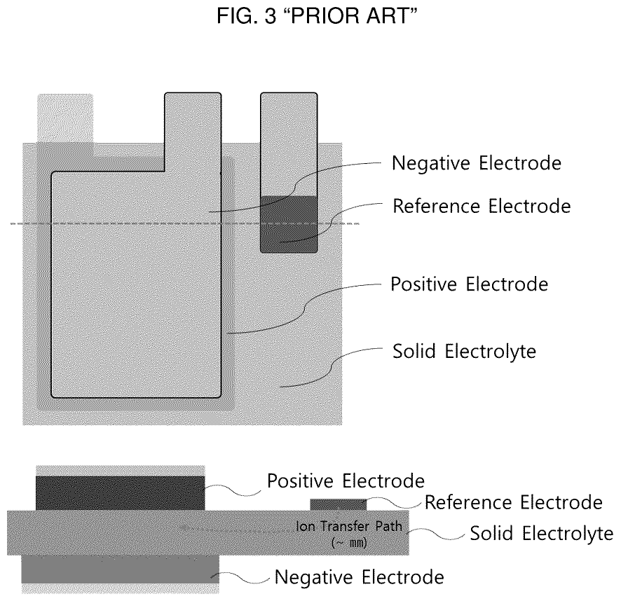

A pouch type all-solid-state battery disclosed in Korean Unexamined Patent Publication No. 10-2022-0130346 was set as a comparative example. FIG. 3 briefly shows the pouch type all-solid-state battery according to the comparative example. Referring to FIG. 3, the all-solid-state battery of the comparative example includes a negative electrode, a positive electrode, and a solid electrolyte interposed between the negative electrode and the positive electrode while having a sheet shape. The solid electrolyte includes an electrode receiver in which the negative electrode and the positive electrode are seated, and an extension extending laterally from the electrode receiver while having a predetermined area. A reference electrode is disposed at one surface of the extension.

### Test Example

Potentials of the positive electrode, the negative electrode, and the entirety of cells in each of the all-solid-state batteries according to the example and the comparative example were measured.

[Full-Cell Potential=Voltage of Positive Electrode−Voltage of Negative Electrode]

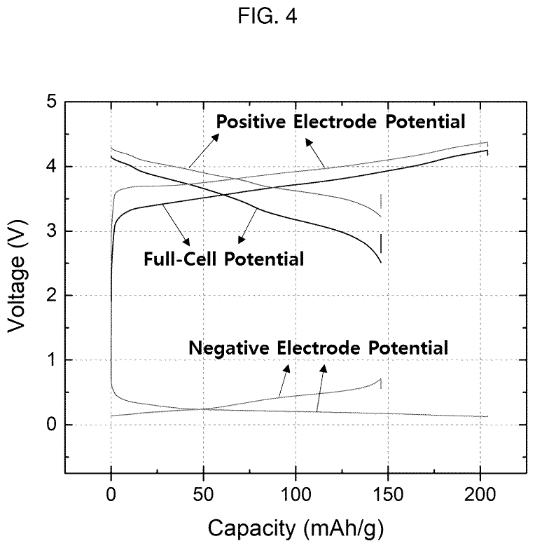

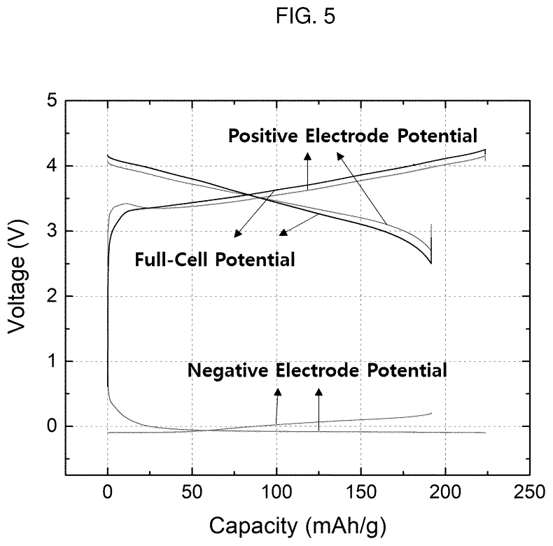

FIGS. 4 and 5 show results of the pouch type all-solid-state batteries according to the example of the present disclosure and the comparative example, respectively. Referring to FIG. 4, it may be seen that, in the example, potentials of the positive electrode and the negative electrode are stably measured without noise, and have reasonable values.

On the other hand, referring to FIG. 5, it may be seen that, in the comparative example, a phenomenon in which the potential of the negative electrode is measured as having a negative value occurred. It may be impossible that such a phenomenon occurs due to materials of the electrodes and, as such, it may be seen that the phenomenon was caused by certain errors. The phenomenon is determined as measurement errors generated because, due to the cell structure of the comparative example, the ion transfer path between the reference electrode and the positive electrode/negative electrode is lengthened 100 to 1,000 times, as compared to that of the example.

When the reference electrode is disposed, as in the comparative example, the ion transfer path between the reference electrode and the actual reaction region is lengthened and, as such, accurate voltage measurement is difficult, and there is a possibility that the solid electrolyte layer may be physically damaged. For this reason, the comparative example, which is the related art, may latently have negative influence on cell performance due to a different reference electrode disposition, and securing of an accurate voltage measurement value, which is most important, is difficult.

As apparent from the above description, the pouch type all-solid-state battery according to the embodiment of the present disclosure may secure a desired cell performance while having battery specifications similar to actual battery specifications.

The present disclosure has been described in detail with reference to some embodiments thereof. However, it should be appreciated by those having ordinary skill in the art that changes may be made in these embodiments without departing from the principles and spirit of the present disclosure.

What is claimed is:

1. An all-solid-state battery comprising:
a first current collector layer;
a first electrode layer disposed on the first current collector layer;
a solid electrolyte layer disposed on the first electrode layer;
a second electrode layer disposed on the solid electrolyte layer;
a second current collector layer disposed on the second electrode layer;
an ion transfer layer disposed on the second current collector layer; and
a reference electrode disposed on the ion transfer layer,
wherein the second current collector layer comprises at least one hole formed to extend through the second current collector layer in a thickness direction, and at least a portion of the ion transfer layer fills the at least one hole.

2. The all-solid-state battery according to claim 1, wherein the first electrode layer has a thickness of 200 μm or less.

3. The all-solid-state battery according to claim 1, wherein the solid electrolyte layer has a thickness of 150 μm or less.

4. The all-solid-state battery according to claim 1, wherein the second electrode layer has a thickness of 200 μm or less.

5. The all-solid-state battery according to claim 1, wherein the at least one hole includes a plurality of holes.

6. The all-solid-state battery according to claim 1, wherein the at least one hole is disposed at a central portion of the second current collector layer.

7. The all-solid-state battery according to claim 1, wherein the at least one hole has a diameter in a range of 1 to 5 mm.

8. The all-solid-state battery according to claim 1, wherein the ion transfer layer comprises a lithium ion conductive material.

9. The all-solid-state battery according to claim 8, wherein the lithium ion conductive material comprises an oxide-based solid electrolyte, a sulfide-based solid electrolyte, a polymer electrolyte, or a combination thereof.

10. The all-solid-state battery according to claim 1, wherein the at least a portion of the ion transfer layer contacts the second electrode layer.

11. The all-solid-state battery according to claim 1, wherein an area of the ion transfer layer is greater than an area of the reference electrode.

12. The all-solid-state battery according to claim 1, wherein an area of the ion transfer layer is greater than an area of the second electrode layer.

13. The all-solid-state battery according to claim 1, wherein the reference electrode comprises lithium or a lithium alloy.

14. The all-solid-state battery according to claim 1, wherein an area of the reference electrode is 80% to 90% of an area of the second electrode layer.

15. The all-solid-state battery according to claim 1, wherein a distance between one surface of the ion transfer layer facing the reference electrode and the first current collector layer is 1 mm or less.

16. The all-solid-state battery according to claim 1, wherein an ion transfer path is formed by the at least one hole.
